(19) United States
(12) Patent Application Publication
(10) Pub. No.: US 2019/0273447 A1
(43) Pub. Date: Sep. 5, 2019

(54) DISCHARGE GENERATOR

(71) Applicant: DENSO CORPORATION, Kariya-city (JP)

(72) Inventors: Shoichi Takemoto, Kariya-city (JP); Nobuhisa Yamaguchi, Kariya-city (JP)

(21) Appl. No.: 16/288,493

(22) Filed: Feb. 28, 2019

(30) Foreign Application Priority Data
Mar. 2, 2018 (JP) 2018-037826

(51) Int. Cl. H02M 7/539; H01F 27/32; H02M 7/538

(52) U.S. Cl. CPC H02M 7/539; H02M 2007/4815; H02M 7/538; H01F 27/324

(57) ABSTRACT

In a discharge generator, a switch is connected to a DC power source, and a transformer includes a primary coil connected to the switch, and a secondary coil magnetically coupled to the primary coil and connected to a discharge load. A power measuring unit measures input power supplied from the direct-current power source. A control unit controls on-off switching operations of the switch to thereby convert an input direct-current voltage to an alternating-current voltage. The control unit changes a switching frequency of the on switching operations of the switch while performing an analysis of a frequency characteristic of the input power based on change of the switching frequency. The control unit determines whether the discharge load is a normal state or at least one of predetermined failure modes has occurred in the discharge load in accordance with a result of the analysis of the frequency characteristic of the input power.

### CROSS REFERENCE TO RELATED APPLICATIONS

This application is based on and claims the benefit of priority from Japanese Patent Application 2018-037826 filed on Mar. 2, 2018, and the disclosure of this application is incorporated in its entirety herein by reference.

### TECHNICAL FIELD

The present disclosure relates to discharge generators including a discharge load and a resonant inverter connected to the discharge load.

### BACKGROUND

Conventional discharge generators include a discharge load and a resonant inverter connected to the discharge load.

### SUMMARY

A discharge generator according to an exemplary aspect of the present disclosure includes a discharge generator. The discharge generator includes a discharge load, and a resonant inverter for converting a direct-current input voltage supplied from a direct-current power source into an alternating-current voltage, and applying the alternating-current voltage to the discharge load, thus causing the discharge load to perform a discharge mode for generating a discharge. The resonant inverter includes a switch connected to the direct-current power source, and a transformer comprising a primary coil connected to the switch, and a secondary coil magnetically coupled to the primary coil and connected to the discharge load. The discharge generator includes a power measuring unit configured to measure input power supplied from the direct-current power source. The discharge generator includes a control unit configured to

(1) Control on-off switching operations of the switch to thereby convert the input direct-current voltage to the alternating-current voltage;

(2) Change a switching frequency of the on switching operations of the switch while performing an analysis of a frequency characteristic of the input power based on change of the switching frequency

(3) Perform a failure determination of whether the discharge load is a normal state or at least one of predetermined failure modes has occurred in the discharge load in accordance with a result of the analysis of the frequency characteristic of the input power

### BRIEF DESCRIPTION OF THE DRAWINGS

Other aspects of the present disclosure will become apparent from the following description of embodiments with reference to the accompanying drawings in which:

FIG. 1 is a circuit diagram schematically illustrating an overall configuration of a discharge generator according to the first embodiment of the present disclosure;

FIG. 2 is a partial cross-sectional view of a discharge load while the discharge load is in a normal state;

FIG. 3 is a graph schematically illustrating a relationship between a switching frequency and input power upon the discharge load being in the normal state;

FIG. 4 is a partial cross-sectional view of the discharge load while a full short-circuit failure mode has occurred in the discharge load;

FIG. 5 is a graph schematically illustrating a relationship between the switching frequency and the input power while the full short-circuit failure mode has occurred in the discharge load;

FIG. 6 is a partial cross-sectional view of the discharge load while a full open-circuit failure mode has occurred in the discharge load;

FIG. 7 is a graph schematically illustrating a relationship between the switching frequency and the input power while the full open-circuit failure mode has occurred in the discharge load;

FIG. 8 is a partial cross-sectional view of the discharge load while a partial short-circuit failure mode has occurred in the discharge load;

FIG. 9 is a graph schematically illustrating a relationship between the switching frequency and the input power while the partial short-circuit failure mode has occurred in the discharge load;

FIG. 10 is a partial cross-sectional view of the discharge load while a partial open-circuit failure mode has occurred in the discharge load;

FIG. 11 is a graph schematically illustrating a relationship between the switching frequency and the input power while the partial open-circuit failure mode has occurred in the discharge load;

FIG. 12 is a flowchart schematically illustrating a first part of a failure mode identifying routine carried out by a control unit illustrated in FIG. 1;

FIG. 13 is a flowchart schematically illustrating a second part of a failure mode identifying routine following the first part of the flowchart illustrated in FIG. 12;

FIG. 14 is a flowchart schematically illustrating a third part of the failure mode identifying routine following the second part of the flowchart illustrated in FIG. 12;

FIG. 15 is a flowchart schematically illustrating a fourth part of the failure mode identifying routine following the third part of the flowchart illustrated in FIG. 12;

FIG. 16 is a timing chart schematically illustrating an example of a relationship between an output current and the gate voltage according to the first embodiment;

FIG. 17 is a graph schematically illustrating an example of the output voltage and the gate voltage in a continuous mode according to the first embodiment;

FIG. 18 is a timing chart schematically illustrating an example of the output voltage and the gate voltage in the burst mode according to the first embodiment;

FIG. 19 is a circuit diagram schematically illustrating an overall configuration of a discharge generator according to a first modification of the first embodiment of the present disclosure;

FIG. 20 is a circuit diagram schematically illustrating an overall configuration of a discharge generator according to a second modification of the first embodiment of the present disclosure; and

FIG. 21 is a flowchart schematically illustrating a modified second part of a failure mode identifying routine following the first part of the flowchart according to the second embodiment of the present disclosure.

### DETAILED DESCRIPTION OF EMBODIMENT

### Inventor's Viewpoint

A conventional discharge generator for example causes the resonant inverter to generate an alternating-current (AC) voltage, thus applying the AC voltage to the discharge load. This causes the discharge load to generate a discharge.

The discharge generator is installed in, for example, a vehicle. The discharge generator generates, based on the generated discharge, ozone, which is to be supplied to, for example, an exhaust pipe of an internal combustion engine of the vehicle. The ozone supplied to the exhaust pipe reforms exhaust gas output from the internal combustion engine via the exhaust pipe.

The discharge load may deteriorate through long-term use thereof. Using the discharge generator in severe environmental conditions, which include severe thermal conditions and/or severe vibration conditions, may cause the discharge generator to suffer a short-circuit fault or failure. For detecting a short-circuit failure, the discharge generator includes a failure detector for detecting a short-circuit failure having occurred in the discharge load. The discharge generator is configured to stop generation of a discharge when the failure detector detects a short-circuit failure having occurred in the discharge generator.

The discharge load is comprised of a plurality of discharge cells, each of which is configured to generate a discharge. The failure detector is capable of detecting a full short-circuit failure mode in which a short-circuit has occurred in wiring of the discharge load to thereby prevent all the discharge cells from generating a discharge. The failure detector is however incapable of detecting other failure modes. Specifically, the failure modes include, for example, a full open-circuit failure mode, a partial open-circuit failure mode, and a partial short-circuit failure mode in addition to the full short-circuit failure mode.

The full open-circuit failure mode represents a failure mode in which a part of wiring of the discharge load has open-circuited to thereby prevent all the discharge cells from generating a discharge.

The partial open-circuit failure mode represents a failure mode in which a part of the wiring has open-circuited to thereby prevent only a part of the discharge cells from generating a discharge.

The partial short-circuit failure mode represents a failure mode in which a short-circuit has occurred in a part of the discharge cells to thereby prevent only a part of the discharge cells from generating a discharge.

Users of such discharge generators therefore require these discharge generators to be capable of detecting at least one of the other failure modes in addition to the full short-circuit mode if at least one of the other failure modes has occurred in their discharge loads.

From the above inventor's viewpoint, the following describes embodiments of the present disclosure with reference to the accompanying drawings. In the embodiments, like parts between the embodiments, to which like reference characters are assigned, are omitted or simplified to avoid redundant description.

### First Embodiment

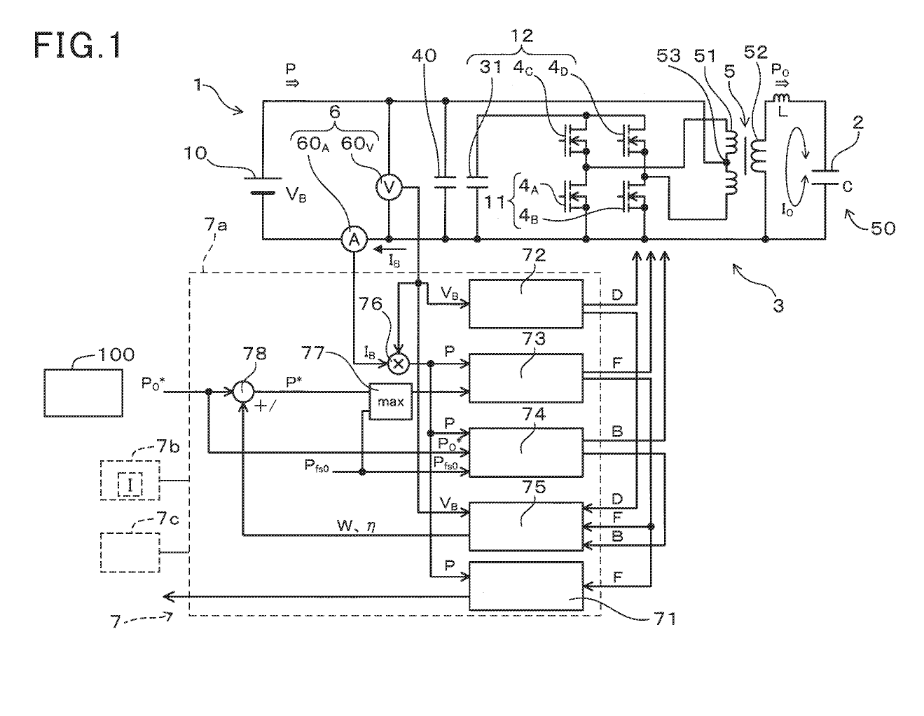

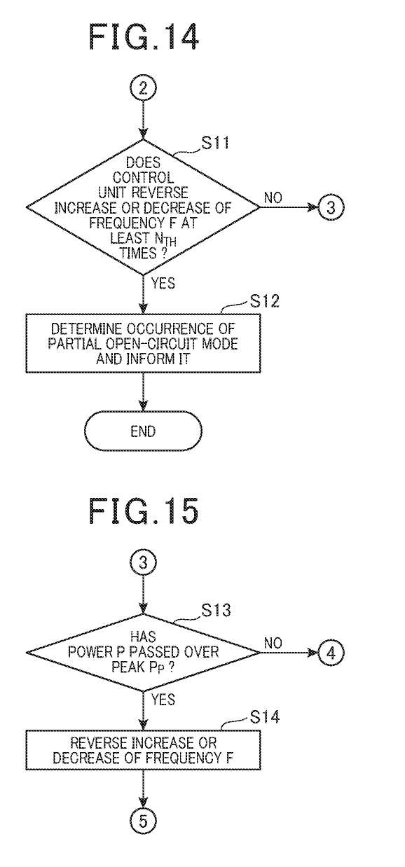

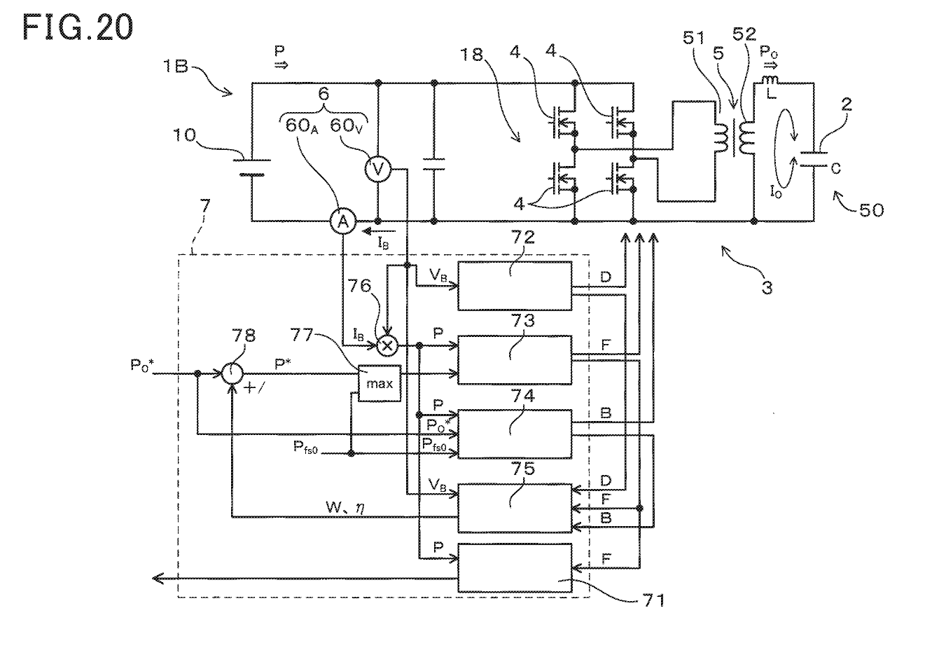

First, the following describes a discharge generator 1 according to the first embodiment of the present disclosure with reference to FIGS. 1 to 20.

For example, the discharge generator 1 according to the first embodiment is applied to be installed in a vehicle.

Referring to FIG. 1, the discharge generator 1 includes a discharge load 2, a resonant inverter 3, and a control unit 7. The control unit 7 can be incorporated in the resonant inverter 3.

The resonant inverter 3 includes switches 4 electrically connected to a direct-current (DC) power source 8.

For example, the control unit 7 is comprised of, for example, a microcomputer including a CPU 7a, a memory 7b, and a peripheral circuit 7c. At least part of all functions provided by the control unit 7 can be implemented by at least one processor; the at least one processor can be comprised of

(1) The combination of at least one programmed processing unit, i.e. at least one programmed logic circuit, and at least one memory

(2) At least one hardwired logic circuit

(3) At least one hardwired-logic and programmed-logic hybrid circuit

Specifically, the control unit 7 controls on-off switching operations of each switch 4 to thereby convert input DC power P input from the DC power source 10 into AC power P_{O}, and outputs the AC power P_{O} to a resonant circuit 50 including the discharge load, such as a capacitive load, 2 while causing a switching frequency, i.e. a drive frequency, F of each switch 4 to resonate with a predetermined resonant frequency of the resonant circuit 50, thus applying a boosted AC voltage to the discharge load 2. This causes the discharge load 2 to generate a discharge.

For example, a discharge reactor for generating ozone, which is to be supplied to, for example, an exhaust pipe of an internal combustion engine of the vehicle, is used as the discharge load 2. That is, the discharge generator 1 is configured to apply a boosted AC voltage across the discharge reactor, i.e. the discharge load 2, thus causing the discharge reactor 2 to generate ozone. The generated ozone is supplied to the exhaust pipe, and operative to reform exhaust gas output from the internal combustion engine via the exhaust pipe.

The resonant inverter 3 includes first to fourth switches 4_{A} to 4_{D} as the switches 4, a transformer 5, a smoothing capacitor 40, and a capacitor 31. The first and second switches 4_{A} and 4_{B} constitute a push-pull circuit 11. The third and fourth switches 4_{C} and 4_{D} and the capacitor 31 constitute a resonant tank circuit 12.

The DC power source 10 has opposing positive and negative terminals, and the smoothing capacitor 40 has opposing positive and negative electrodes. The smoothing capacitor 40 is connected in parallel to the DC power source 10. The smoothing capacitor 40 is operative to smooth a DC voltage V_{B} supplied from the DC power source 10.

The transformer 5 is comprised of a primary coil 51, a secondary coil 52, and a substantially cylindrical core (not shown). The primary coil 51 is wound around a part of the core, and the secondary coil 52 is wound around another part of the core such that the primary coil 51 is electrically isolated from the secondary coil 52 and magnetically linked thereto. The number of turns of the secondary coil 52 is set to be larger than the number of turns of the primary coil 51.

The primary coil 51 has a center tap 53 that divides the primary coil 51 into a first coil member 51ₐ and a second coil member 51_{b}. The first coil member 51ₐ has a first end and a second end serving as the center tap 53, and the second coil member 51_{b} has a first end and a second end serving as the center tap 53.

The center tap 53 is connected to the positive electrode of the smoothing capacitor 24 and also to the positive terminal of the DC power source 10. The secondary coil 52 has opposing first and second ends. The first end of the secondary coil 52 is connected to a first electrode of the discharge load 2, and the second end of the secondary coil 52 is connected to the negative electrode of the smoothing capacitor 40 and also to the negative terminal of the DC power source 10 via a common signal ground. A second electrode of the discharge load 2 is connected to the negative electrode of the smoothing capacitor 40 and also to the negative terminal of the DC power source 10 via the common signal ground.

Each of the first and second switches 4_{A} and 4_{B} is comprised of a switching element, such as a MOSFET (MOS) whose intrinsic diode serves as a flyback or free-wheel diode. An IGBT can be used as the switching element. An additional diode can be used to be connected in antiparallel to each switching element as a flyback diode. The first switch 4_{A} is connected between the first end of the first coil member 51ₐ and the negative electrode of the smoothing capacitor 40 via the common signal ground. Specifically, the first main switch 4_{A} has a first end connected to the first end of the first coil member 51a, and a second end connected to the negative electrode of the smoothing capacitor 40 via the common signal ground.

The second switch 4_{B} is connected between the first end of the second coil member 51_{b} and the negative electrode of the smoothing capacitor 40 via the common signal ground. Specifically, the second switch 4_{B} has a first end connected to the first end of the second coil member 51_{b}, and a second end connected to the negative electrode of the smoothing capacitor 40 via the common signal ground.

The first and second switches 4_{A} and 4_{B} and the third and fourth switches 4_{C} and 41_{D} constitute a bridge circuit according to the first embodiment.

The capacitor 31 is comprised of a pair of positive and negative electrodes separated from one another. The positive electrode of the capacitor 31 is connected to the positive electrode of the smoothing capacitor 40, and the negative electrode of the capacitor 31 is connected to the negative electrode of the smoothing capacitor 40 via the common signal ground. The capacitor 31 has a predetermined capacitance.

The third switch 4_{C} is connected between the positive electrode of the capacitor 31 and the connection point between the first switch 4_{A} and the first coil member 51ₐ. Specifically, the third switch 4_{C} has a first end connected to the positive electrode of the capacitor 31, and has a second end connected to the connection point between the first switch 4_{A} and the first coil member 51ₐ.

The fourth switch 4_{D} is connected between the positive electrode of the capacitor 31 and the connection point between the second switch 4_{B} and the second coil member 51_{b}. Specifically, the fourth switch 4_{D} has a first end connected to the positive electrode of the capacitor 31, and has a second end connected to the connection point between the second switch 4_{B} and the second coil member 51_{b}.

Each of the first, second, third, and fourth switches 4_{A}, 4_{B}, 4_{C}, and 4_{D} has a control terminal, which is the gate when the corresponding switch is a MOSFET, connected to the control unit 7.

The control unit 7 is configured to control on-off switching operations of each of the first, second, third, and fourth switches 4_{A}, 4_{B}, 4_{C}, and 4_{D}.

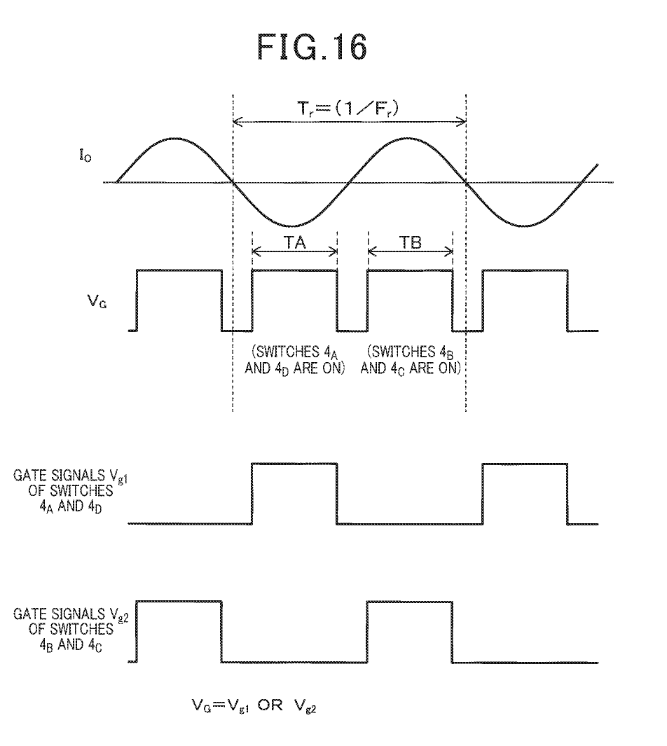

For example, as illustrated in FIG. 16, the control unit 7 is configured to control the first, second, third, and fourth switches 4_{A}, 4_{B}, 4_{C}, and 4_{D} in a first switching pattern and a second switching pattern alternately.

Specifically, the control unit 7 is configured in the first switching pattern to turn on and hold on the first switch 4_{A} and the fourth switch 4_{D} based on a value V_{g1} of a control voltage, i.e. a gate voltage V_{G}, during a predetermined duration TA while holding off the second switch 4_{B} and the third switch 4_{C}.

Additionally, the control unit 7 is configured in the second switching pattern to turn on and hold on the second switch 4_{B} and the third switch 4_{C} based on a value V_{g2} of the control voltage, i.e. the gate voltage V_{G}, during a predetermined duration TB, which is set to be equal to the duration TA, while holding off the first switch 4_{A} and the fourth switch 4_{D}.

That is, the control unit 7 is configured to switch between the first switching pattern and the second switching pattern to cause the switching frequency f of each of the first to fourth switches 4_{A} to 4_{D} to be close to a predetermined resonant frequency of the resonant circuit 50, i.e. resonate with a predetermined resonant frequency of the resonant circuit 50.

This causes the input power P to be converted into the AC power P_{O} as the output of the secondary coil 52 while causing the frequency of an output current, i.e. an output alternating current, Io output from the secondary coil 52 as the output power P_{O} to resonate with the resonant frequency of the resonant circuit 50. This boosts the output current Io, i.e. output power.

Note that the control unit 7 is configured to

(1) Turn on one of the switches 4_{A} and 4_{C} when a dead time has elapsed since turn off of the other of the switches 4_{A} and 4_{C} to prevent the switches 4_{A} and 4_{C} from being simultaneously in the on state

(2) Turn on one of the switches 4_{B} and 4_{D} when a dead time has elapsed since turn off of the other of the switches 4_{B} and 4_{D} to prevent the switches 4_{B} and 4_{D} from being simultaneously in the on state

In particular, the resonant circuit 50 includes a capacitance C of the discharge load 2 and a leakage inductance L of the secondary winding 52 of the transformer 5 connected to the discharge load 2. That is, the resonant circuit 50 has the resonant frequency, referred to as fr, which is expressed by fr=1/2πLC.

That is, the discharge generator 1 causes the frequency of the output current Io, which is boosted based on the turn ratio between the primary and secondary coils 51 and 52, to resonate with the resonant frequency fr of the resonant circuit 50. This strongly boosts the output current Io, i.e. output power P_{O}, thus generating a very high voltage Vo as the output power P_{O} across the discharge load 2. This causes the discharge load 2 to generate a discharge between its electrodes.

An external controller 100 installed in the vehicle is configured to send a target value for the output power P_{O}, which will be referred to as target output power P_{O}*, to the control unit 7 every predetermined control cycle.

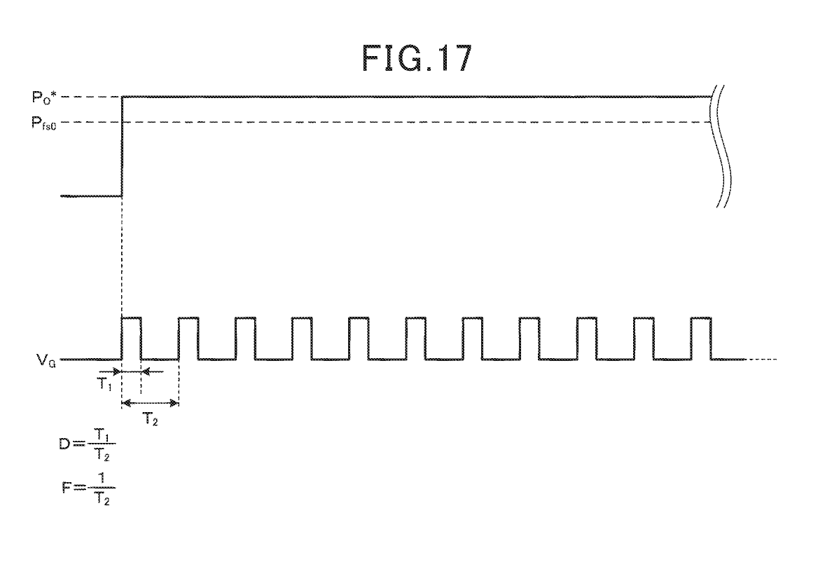

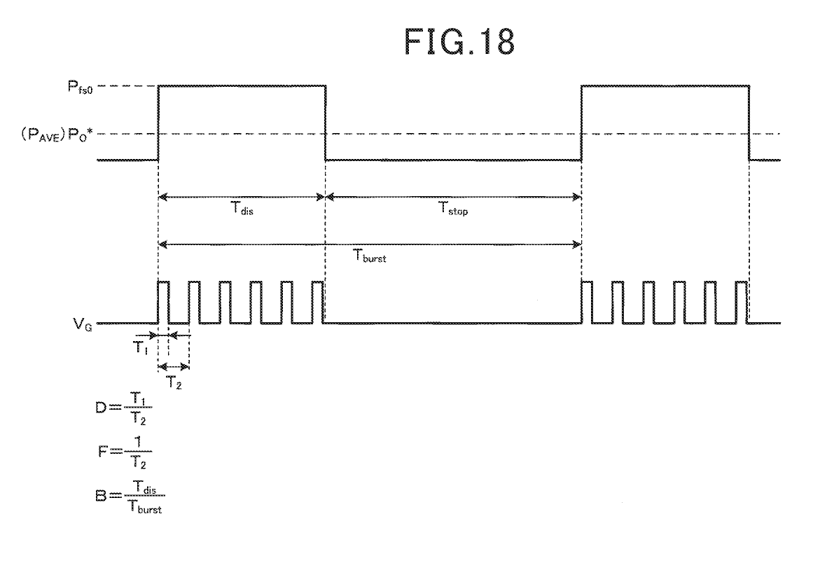

The control unit 7 is configured to switchably, i.e. selectably, perform a continuous mode (see FIG. 17) and a burst mode (see FIG. 18). That is, the control unit 7 is configured to perform the continuous mode upon determining that the target output power P_{O}* is higher than predetermined discharge start power P_{fs0}; the discharge start power P_{fs0} represents predetermined minimum power required for the discharge load 2 to generate discharge.

When performing the continuous mode, the control unit 7 continuously performs, based on the gate voltage V_{G}, alternating turn-on of the first set of the switches 4_{A} and 4_{D} in the first switching pattern and the second set of the switches 4_{B} and 4_{C} in the second switching pattern using a duty factor D every switching cycle F. The duty factor D for each switch represents a controllable ratio, i.e. percentage, of an on duration (see T1 in each of FIGS. 17 and 18) of the switch to a total duration (see T2) of the switching cycle F (see FIGS. 17 and 18).

In contrast, the control unit 7 is configured to perform the burst mode upon determining that the target output power P_{O}* is equal to or lower than the discharge start power P_{fs0}.

When performing the burst mode, the control unit 7 alternately performs a discharge mode M1 and a non-discharge mode M2. In other words, the control unit 7 cyclically performs the set of the discharge mode M1 and the non-discharge mode M2 in the burst mode. One cycle of the set of the discharge mode M1 and the non-discharge mode M2 will be referred to as a burst cycle.

In the discharge mode M1, the control unit 7 controls alternating turn-on of the first set of the switches 4_{A} and 4_{D} based on the gate voltage V_{G} in the first switching pattern and the second set of the switches 4_{B} and 4_{C} based on the gate voltage V_{G} in the second switching pattern during a predetermined first discharge period T_{dis} to thereby cause the discharge load 2 to generate a discharge and sustain the generated discharge.

In the non-discharge mode M2, the control unit 7 drives no switches 4_{A} to 4_{D} in a predetermined stop period Tₛₜₒₚ to thereby prevent the discharge load 2 from generating a discharge.

The first discharge period T_{dis} of a switch represents a period during which the first set of the switches 4_{A} and 4_{D} and the second set of the switches 4_{B} and 4_{C} are alternatively turned on every switching cycle F. The stop period Tₛₜₒₚ of a switch refers to a period during which the switch is kept off. Note that the sum of the first discharge period T_{dis} and the stop period Tₛₜₒₚ constitute a burst period T_{burst} (see FIG. 18).

Specifically, the control unit 7 is configured to control a burst ratio B, which is expressed by the following equation (1), to thereby cause the main circuit unit 2 to output the output power P_{O} that is equal to or higher than the discharge start power P_{fs0} during the first discharge period T_{dis}:

B=T_{dis}/T_{burst} (1)

Referring to FIG. 1, the control unit 7 includes a failure determiner 71, a duty controller 72, a frequency controller 73, a burst controller 74, a calculator 75, a multiplier 76, a selector 77, and an input power calculator 78.

The resonant inverter 3 includes a power measurement unit 6 comprised of a voltage sensor 60_{V} and a current sensor 60_{A}. The voltage sensor 60_{V} is connected in parallel to the DC power source 10 and the smoothing capacitor 40, and is configured to measure the DC voltage V_{B} output from the DC power source 10. Then, the voltage sensor 60_{A} is configured to output, to the control unit 7, a measurement signal indicative of a measured value of the DC voltage V_{B}. The power measurement unit 6 can be separated from the resonant inverter 3.

The current sensor 60_{A} is connected between the negative electrode of the smoothing capacitor 40 and the negative terminal of the DC power source 10, and is configured to measure an input current I_{B} output from the DC power source 10 and input to the resonant inverter 3. Then, the current sensor 60_{A} is configured to output, to the control unit 7, a measurement signal indicative of a measured value of the input current I_{B}.

The measurement signal indicative of the measured value of the DC voltage V_{B} is input to, for example, each of the duty controller 72 and the power corrector 75.

The measurement signal indicative of the measured value of the DC voltage V_{B} and the measurement signal indicative of the measured value of the input current I_{B} are also input to the multiplier 76.

The multiplier 76 is configured to multiply the measured value of the DC voltage V_{B} and the measurement measured value of the input current I_{B} are also input to the multiplier 76 between each other to thereby calculate the input power P. The calculated input power P is input to, for example, each of the failure determiner 71, the frequency controller 73, and the burst controller 74.

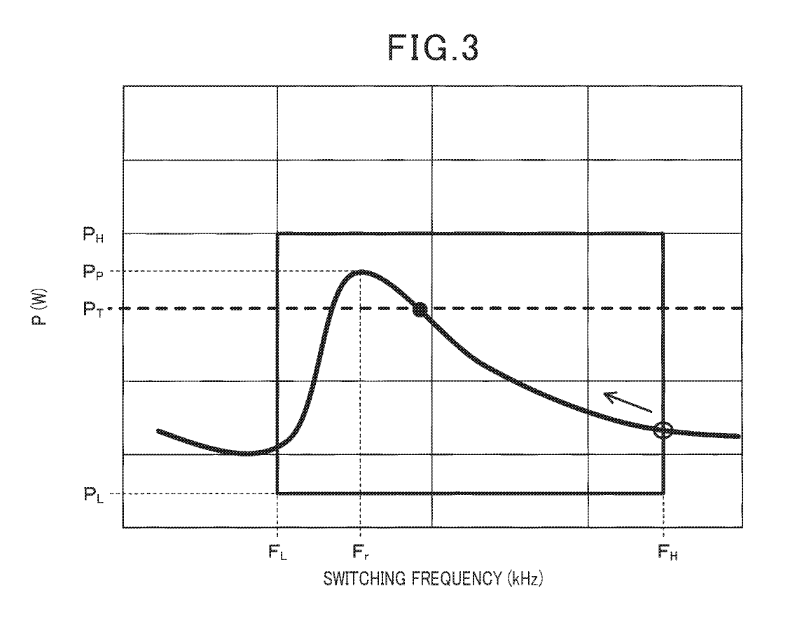

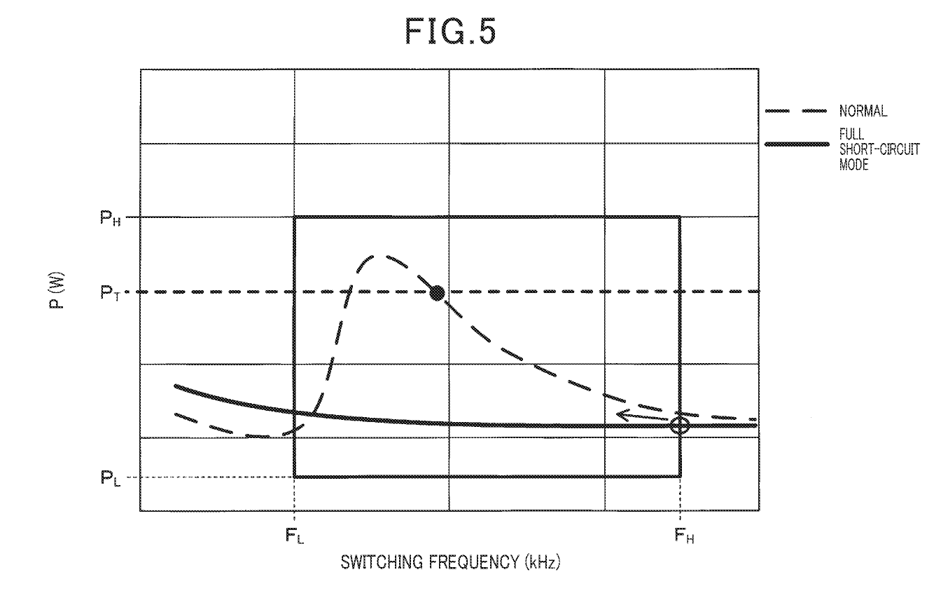

The failure determiner 71 is configured to change the frequency f of each switch 4 while monitoring and analyzing a frequency characteristic of the input power P (see FIG. 3 or 5). This monitor and analysis enables whether the discharge load 2 is in a normal state or at least one of a plurality of failure modes has occurred in the discharge load 2.

The duty controller 72 is configured control the duty factor D of each of the first to fourth switches 4_{A} to 4_{D} (see FIGS. 17 and 18), and the frequency controller 73 is configured to control the switching frequency F of each of the first to fourth switches 4_{A} to 4_{D}.

The burst controller 74 is configured to control the burst ratio B of each of the first to fourth switches 4_{A} to 4_{D} (see FIG. 18).

That is, controlling the duty factor D, the switching frequency F, the burst ratio B of each of the first to fourth switches 4_{A} to 4_{D} causes the output power P_{O} to be closer to the target output power P_{O}*.

Specifically, the duty controller 72 is configured to perform feedforward control of the duty factor D of each switch 4 in accordance with the measured value of the DC voltage V_{B}.

The frequency controller 73 is configured to perform feedback control of the switching frequency F of each switch 4 such that the deviation of the input power P from target input power P_{I}* or the discharge start power P_{fs0} input from the selector 77 described later becomes smaller.

The DC power source 10 according to the first embodiment, which is for example, designed as a lead storage battery, is connected to, in addition to the discharge generator 1, a plurality of electrical loads including, for example, an air-conditioner and lights installed in the vehicle. The DC voltage V_{B} of the DC power source 10 may therefore suddenly vary depending on the usage situations of the electrical loads. This sudden variation of the DC voltage V_{B} of the DC power source 10 may cause the output power P_{O} to be suddenly deviate from the target output power P_{O}*.

From this viewpoint, the control unit 7 is configured to, even if the output power P_{O} suddenly deviates from the target output power P_{O}*, perform the feedforward control of the duty factor D of each switch 4 in accordance with the measured value of the DC voltage V_{B} to thereby immediately return the deviated output power P_{O} to the target output power P_{O}*.

For example, if the DC voltage V_{B} of the DC power source 10 suddenly decreases, so that the output power P_{O} also suddenly decreases, the control unit 7 performs the power control task to increase the duty factor D of each switch 4 while maintaining the switching frequency F thereof at a constant value. This results in an increase of the output power P_{O}.

Specifically, the control unit 7 performs feedforward control of the duty factor D of each switch 4 using the DC voltage V_{B} of the DC power source 10. This feedforward control of the duty factor d of each switch 21 enables the output power P_{O} to be returned to a value relatively close to the target output power P_{O}* in a shorter time.

After the feedforward control of the duty factor D of each switch 4, the power control task performs feedback control of the switching frequency F of each switch 4. This feedback control of the switching frequency F of each switch 4 enables the output power P_{O} to be precisely closer to the target output power P_{O}* although this feedback control takes some time.

That is, if the output power P_{O} suddenly changes, the control unit 7 performs feedforward control of the duty factor D of each switch 4 to thereby return the output power P_{O} to a value relatively close to the target output power P_{O}* first, and thereafter performs feedback control of the switching frequency F of each switch 4 to thereby cause the output power P_{O} to be precisely closer to the target output power P_{O}*.

The burst controller 74 is configured to calculate, based on the discharge start power P_{fs0} and the target output power P_{O}*, the burst ratio B in accordance with the equation (1) set forth above.

These parameters D, F, B, and the DC voltage V_{B} are input to the calculator 75.

The calculator 75 is configured to calculate

(1) Power loss W of the resonant inverter 3 based on values of these parameters D, F, and V_{B} in accordance with, for example, a predetermined relation equation or map among the power loss W and these parameters D, F, and V_{B} if the continuous mode is carried out

(2) The power loss W of the resonant inverter 3 based on values of these parameters D, F, and V_{B} in accordance with, for example, a predetermined relation equation or map among the power loss W and these parameters D, F, and V_{B} if the burst mode is carried out

Then, the calculator 75 is configured to output the value of the power loss W to the input power calculator 78.

In addition, as described above, the target output power P_{O}* sent from the external controller 100 to the control unit 7 is input to each of the input power calculator 78 and the selector 77.

The input power calculator 78 receives the target output power P_{O}* and the value of the power loss W, and adds the value of the power loss W to the target output power P_{O}*, thus calculating target input power P* and outputting the calculated target input power P_{I}* to the selector 77.

If the target input power P_{I}* were input to the resonant inverter 3, the power loss W would be generated in the resonant inverter 3. For this reason, the discharge generator 1 is configured such that the resonant inverter 3 outputs a value of the output power P_{O}, which is substantially equal to the subtraction of the power loss W from the target input power P*, that is, the target output power P_{O}*.

The calculator 75 can be configured to calculate

(1) A circuit efficient η of the resonant inverter 3 based on values of these parameters D, F, and V_{B} in accordance with for example, a predetermined relation equation or map among the circuit efficient η and these parameters D, F, and V_{B} if the continuous mode is carried out

(2) The circuit efficiency η of the resonant inverter 3 based on values of these parameters D, F, and V_{B} in accordance with, for example, a predetermined relation equation or map among the circuit efficiency η and these parameters D, F, and V_{B} if the burst mode is carried out

Then, the calculator 75 can be configured to output the value of the circuit efficiency η to the input power calculator 78.

At that time, the input power calculator 78 receives the target output power P_{O}* and the value of the circuit efficiency η, and divides the target output power P_{O}* by the value of the circuit efficiency η, thus calculating the target input power P_{I}* and outputting the calculated target input power P* to the selector 77.

The selector 77 is configured to select one of the target input power P* and the discharge start power P_{fs0}; the selected one of the target input power P* and the discharge start power P_{fs0} is higher than the other thereof. Then, the selector 77 is configured to output, to the frequency controller 73, the selected one of the target input power P* and the discharge start power P_{fs0}.

That is, power input to the frequency controller 73 is always equal to or higher than the discharge start power P_{fs0}.

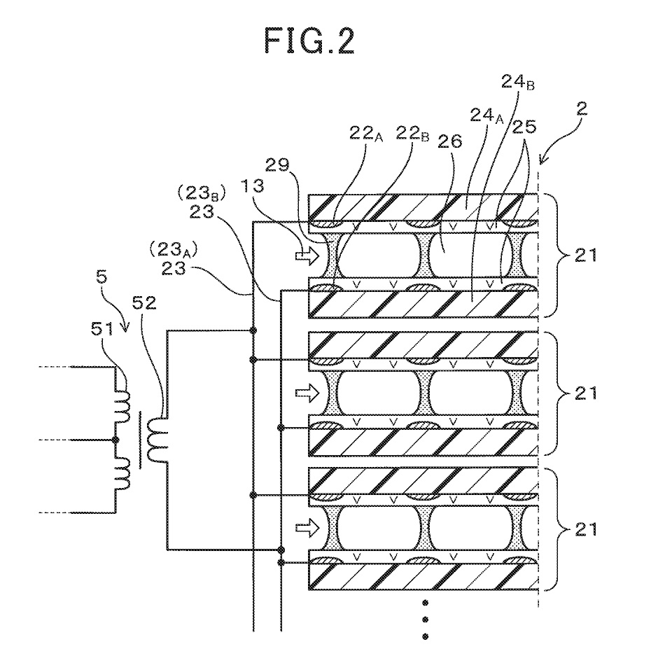

Next, the following describes an example of the structure of the discharge load 2 with reference to FIG. 2. Referring to FIG. 2, the discharge load 2 is comprised of a plurality of discharge cells 21 each for generating a discharge.

Each of the discharge cells 21 is comprised of a pair of first and second insulator substrates 24A and 24B arranged to face each other.

Each of the discharge cells 21 is also comprised of first discharge electrodes 22A mounted to an inner surface of the first insulator substrate 24A, and second discharge electrodes 22B mounted to an inner surface of the second insulator substrate 24B; the second discharge electrodes 22B face the respective first discharge electrodes 22A. Each of the discharge cells 21 can include at least one pair of the first and second discharge electrodes 22A and 22B.

Each of the discharge cells 21 is comprised of a pair of barrier layers 25 respectively mounted on the inner surfaces of the first and second insulator substrates 24A and 24B. The barrier layer 25 mounted on the inner surface of the first insulator substrate 24A covers the first discharge electrodes 22A, and the barrier layer 25 mounted on the inner surface of the second insulator substrate 24B covers the second discharge electrodes 22B. The barrier layers 25 are arranged to face each other with an air channel 26 therebetween through which air, such as exhaust air, 13 is introduced to flow.

The discharge load 2 is also comprised of a first wire member 23A connecting between the first end of the secondary coil 52 and each of the first discharge electrodes 22A, and a second wire member 23B connecting between connecting between the second end of the secondary coil 52 and each of the second discharge electrodes 22B. That is, the first discharge electrodes 22A serve as the first electrode of the discharge load 2, and the second discharge electrodes 22B serve as the second electrode of the discharge load 2.

Applying the boosted AC voltage to each discharge cell 21 of the discharge load 2 results in discharges being generated via the air channel 26 between the first discharge electrodes 22A and the second discharge electrodes 22B of the corresponding discharge cell 21. This results in oxygen contained in the exhaust air 13 being changed into ozone.

Before causing the discharge load 2 to perform a discharge mode for generating a discharge to thereby generate ozone, the control unit 7 serves as the failure determiner 71 to determine whether at least one of failure modes has occurred in the discharge load 2. In other words, the control unit 7 serves as the failure determiner 71 to determine whether at least one of failure modes has occurred in the discharge load 2 while changing the switching frequency F independently of the target output power P_{O}*.

Note that the control unit 7 can be configured to determine whether at least one of failure modes has occurred in the discharge load 2 after controlling the resonant inverter 3 to apply the boosted AC voltage to each discharge cell 21, i.e. after causing the discharge load 2 to generate ozone.

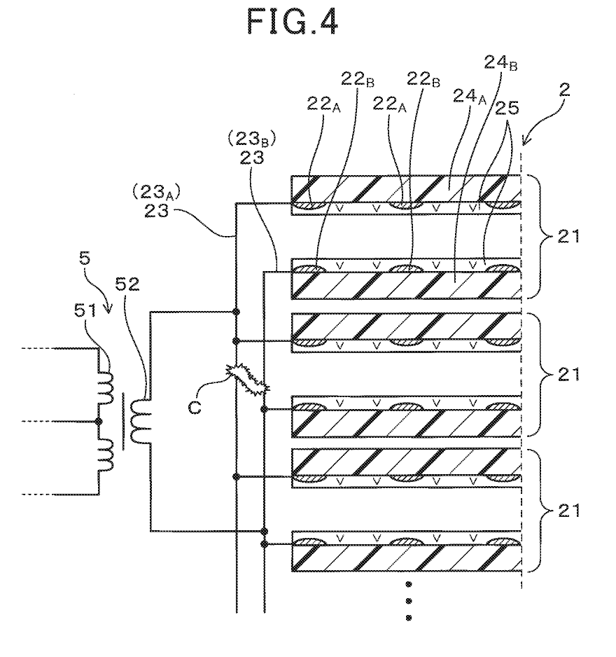

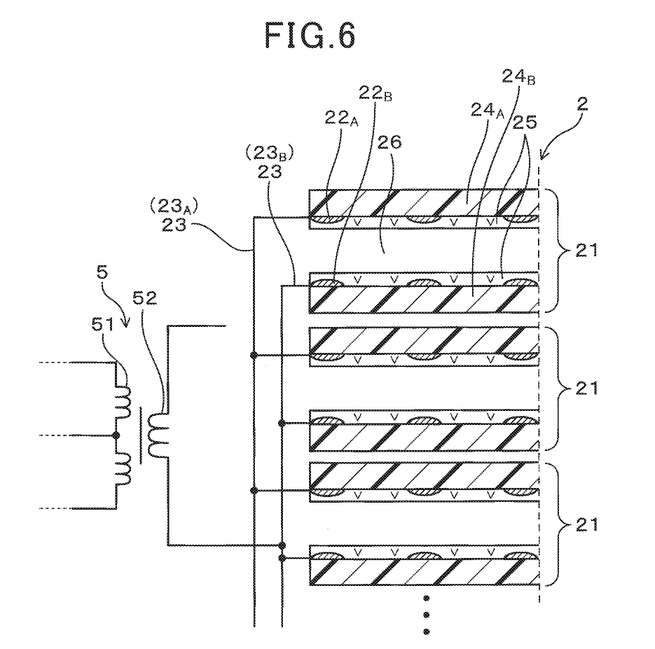

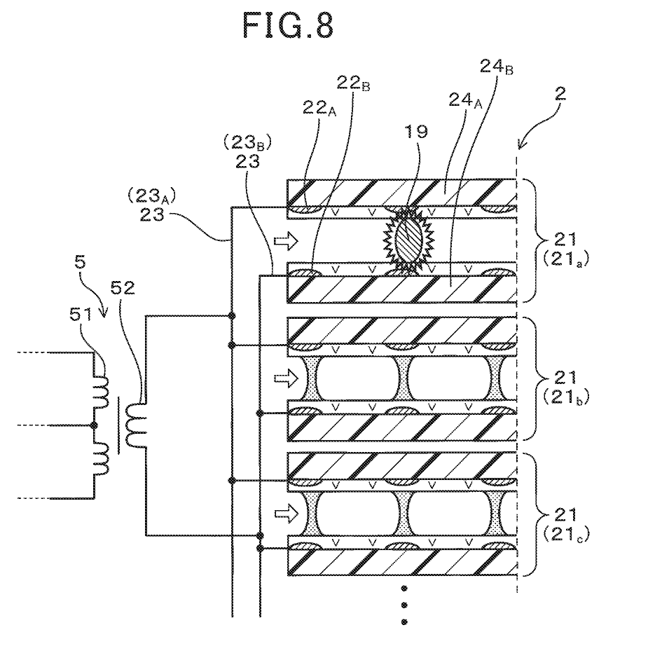

The failure modes for the discharge load 2 include, for example, a full short-circuit failure mode (see FIG. 4), a full open-circuit failure mode (see FIG. 6), a partial short-circuit failure mode (see FIG. 8), and a partial short-circuit failure mode. The failure determiner 71 is configured to analyze the frequency characteristic of the input power P to thereby determine whether at least one of the failure modes has occurred in the discharge load 2.

The full short-circuit failure represents a failure in which a short-circuit between the first and second wire members 23A and 23B has occurred to thereby prevent all the discharge cells 21 from generating discharges (see FIG. 4).

The full open-circuit failure mode represents a failure mode in which a part of one of the first and second wire members 24A and 24B has open-circuited to thereby prevent all the discharge cells 21 from generating discharges (see FIG. 6).

The partial short-circuit failure mode represents a failure mode in which a part of the discharge cells 21, such as a discharge cell 21a in the discharge cells 21b, 21c, . . . , has short-circuited (see FIG. 8). For example, an intrusion of electrically conductive foreign matter, such as metallic matter, 19 into the air channel 26 of the discharge cell 21a may cause a large short-circuit current to flow between a part of the first insulator substrate 24A and an opposing part of the second insulator substrate 24B via the electrically conductive foreign matter 19 without little short-circuit current flowing through other parts of the first and second insulator substrates 24A and 24B. The other discharge cells 21, such as discharge cells 21b and 21c, is operating normally.

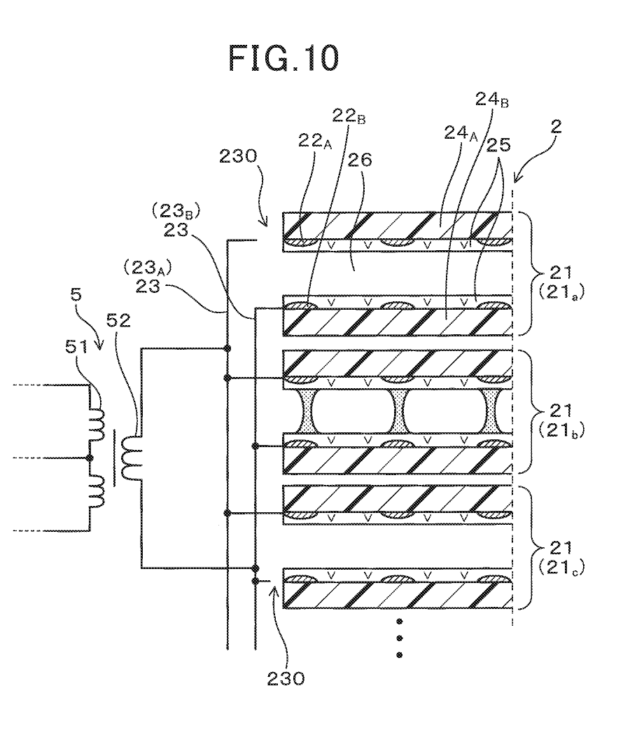

The partial open-circuit failure mode represents a failure mode in which, for example, a part 230 of the first wire member 23A connected to the discharge cell 21a has open-circuited, and a part 230 of the second wire member 23B connected to the discharge cell 21c has open-circuited (see FIG. 10), so that a part of the discharge cells 21, i.e. the discharge cells 21a and 21c, cannot generate discharges while the other discharge cells 21, such as the discharge cell 21b, is operating normally.

Next, the following describes how the failure determiner 71 determines whether at least one of the failure modes has occurred in the discharge load 2 in accordance with the frequency characteristic of the input power P.

First, the following describes how the control unit 7, i.e. the failure determiner 71, determines that the discharge load 2 is operating normally based on the frequency characteristic of the input power P.

FIG. 3 schematically illustrates the frequency characteristic of the input power P relative to the switching frequency F of each switch 4 as a graph. FIG. 3 shows that, if the discharge load 2 is operating normally, the closer the switching frequency F to the resonant frequency Fr is, the higher the input power P is, and the input power P is maximized to have peak P_{P} when the switching frequency F becomes the resonant frequency Fr. FIG. 3 also shows that, if the discharge load 2 is operating normally, the farther the switching frequency F from the resonant frequency Fr is, the lower the input power P is.

For example, the control unit 7 stores, in the memory 7b, an example of information I including

(1) A predetermined range of the switching frequency F from a predetermined lowest frequency F_{L} to a predetermined highest frequency F_{H} inclusive, which will be referred to as a frequency range F_{H} to F_{L}

(2) A range of the input power P from lowest input power P_{L} to highest input power P_{H} inclusive

(3) A target value P_{T} of the input power P, which is previously determined within the range of the input power P from the lowest input power P_{L} to the highest input power P_{H} inclusive

The range of the input power P from the lowest input power P_{L} to the highest input power P_{H} inclusive will be referred to as an input power range P_{L} to P_{H}.

FIG. 3 shows that, if the discharge load 2 is operating normally, the resonant frequency Fr is located within the frequency range F_{H} to F_{L}, and the peak P_{P} of the input power P is located within the range between the highest input power P_{H} and the target value P_{T} of the input power P inclusive. FIG. 3 also shows that input power P is limited within the range between the lowest input power P_{L} and the highest input power P_{H} even if the switching frequency F set to any value within the frequency range F_{H} to F_{L}.

Specifically, the control unit 7 serves as the failure determiner 71 to adjust the switching frequency F of each switch 4 to the highest frequency F_{H}, and decrement the switching frequency F from the highest frequency F_{H} toward the lowest frequency F_{L} by a predetermined minute frequency ΔF while determining whether the input power P has reached the target value P_{T}. The control unit 7 serves as the failure determiner 71 to determine that the discharge load 2 is in the normal state upon determining that

(1) The input power P has reached the target value P_{T}

(2) At least one additional requirement is satisfied

Next, the following describes how the control unit 7, i.e. the failure determiner 71, determines that the full short-circuit failure mode has occurred in the discharge load 2 based on the frequency characteristic of the input power P.

As illustrated in FIG. 4, a short-circuit having occurred between the first and second wire members 23A and 23B in the short-circuit failure mode results in no discharges being generated in the discharge load 2. The short-circuit having occurred between the first and second wire members 23A and 23B causes the frequency of the output current, i.e. the secondary current, Io to resonate with a resonant frequency determined based on the leakage inductance L (see FIG. 1) and a parasitic capacitance C′ between the wire members 23A and 23B.

This results in, as illustrated in FIG. 5, the resonant frequency determined based on the leakage inductance L and the parasitic capacitance C′ is shifted to be located outside the frequency range F_{H} to F_{L}. This results in the input power P having not reached the target value P_{T} even if the failure determiner 71 changes the switching frequency F within the frequency range F_{H} to F_{L}. The full short-circuit failure mode having occurred in the discharge load 2 causes the input power P to drop overall without being completely zero as compared with that obtained when the discharge load 2 is operating normally.

Specifically, the control unit 7 serves as the failure determiner 71 to adjust the switching frequency F of each switch 4 to the highest frequency F_{H}, and decrement the switching frequency F from the highest frequency F_{H} toward the lowest frequency F_{L} by the predetermined minute frequency ΔF while determining whether the input power P has reached the target value P_{T}. The control unit 7 serves as the failure determiner 71 to determine that the full short-circuit failure mode has occurred in the discharge load 2 upon determining that the input power P has not reached the target value P_{T} and is located within the input power range P_{L} to P_{H} when the switching frequency F becomes the lowest frequency F_{L}.

Next, the following describes how the control unit 7, i.e. the failure determiner 71, determines that the full open-circuit failure mode has occurred in the discharge load 2 based on the frequency characteristic of the input power P.

As illustrated in FIG. 6, a part of one of the first and second wire members 23A and 23B having open-circuited in the full open-circuit failure mode results in no discharges being generated in the discharge load 2. The open-circuit having occurred in one of the first and second wire members 23A and 23B causes no output current, i.e. secondary current, Io to flow through the secondary coil 52, resulting in the input power P being approximately 0 (W).

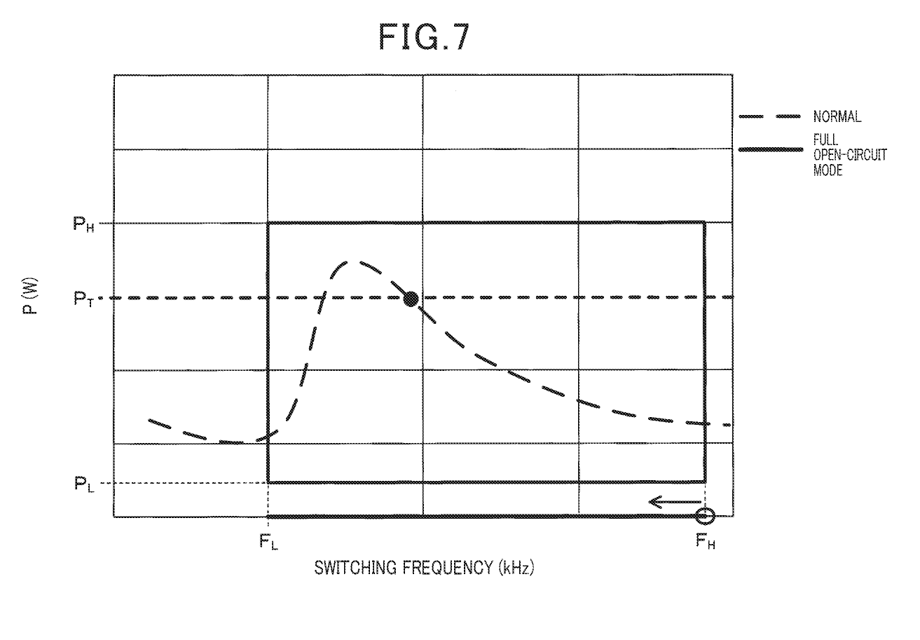

This results in, as illustrated in FIG. 7, the input power P being maintained at approximately 0 (W), which is lower than the lowest input power P_{L} even if the failure determiner 71 changes the switching frequency F within the frequency range F_{H} to F_{L}.

Specifically, the control unit 7 serves as the failure determiner 71 to adjust the switching frequency F of each switch 4 to the highest frequency F_{H}, and decrement the switching frequency F from the highest frequency F_{H} toward the lowest frequency F_{L} by the predetermined minute frequency ΔF while determining whether the input power P has reached the target value P_{T}. The control unit 7 serves as the failure determiner 71 to determine that the full open-circuit failure mode has occurred in the discharge load 2 upon determining that the input power P is located outside the input power range P_{L} to P_{H} when the switching frequency F becomes the lowest frequency F_{L}.

Next, the following describes how the control unit 7, i.e. the failure determiner 71, determines that the partial short-circuit failure mode has occurred in the discharge load 2 based on the frequency characteristic of the input power P.

As illustrated in FIG. 8, in the partial short-circuit failure mode, electrically conductive foreign matter 19 introduced in the air channel 26 of the discharge cell 21a in the discharge cells 21 causes the discharge cell 21a to only have short-circuited. This results in a total resistance R of the discharge load 2 being lower, so that a quality factor Q of the resonance behavior by the resonant inverter 3, which is expressed by “Q=(1/R)·\sqrt{(L/C)}”, is higher.

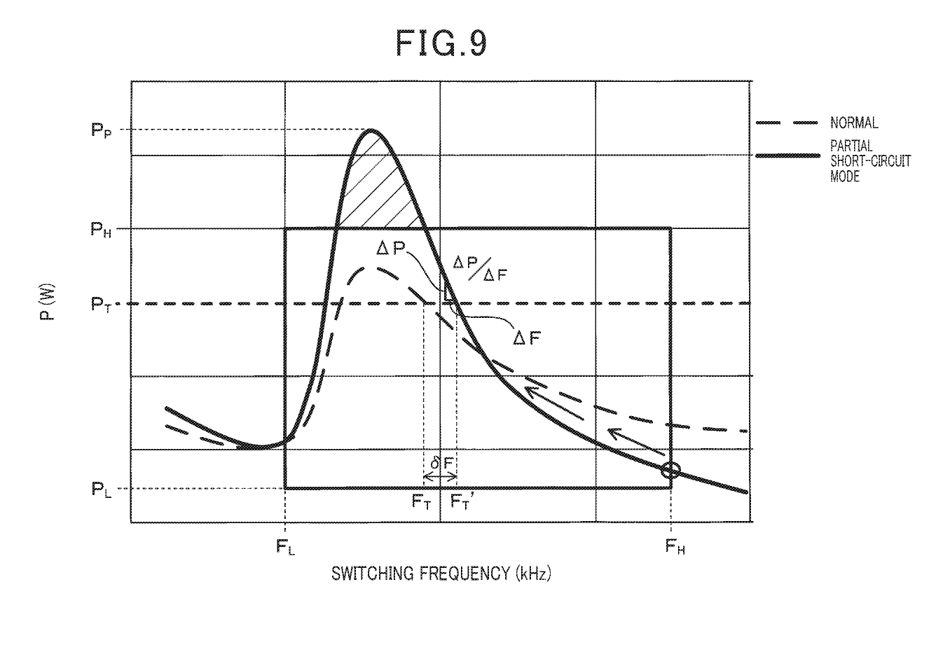

This results in, as illustrated in FIG. 9, the peak P_{P} of the input power P becoming higher than its normal value so as to exceed the highest input power P_{H}.

Specifically, the control unit 7 serves as the failure determiner 71 to adjust the switching frequency F of each switch 4 to the highest frequency F_{H}, and decrement the switching frequency F from the highest frequency F_{H} toward the lowest frequency F_{L} by the predetermined minute frequency ΔF while determining whether the input power P has exceeded the highest input power P_{H}. The control unit 7 serves as the failure determiner 71 to determine that the partial short-circuit failure mode has occurred in the discharge load 2 upon determining that the input power P has exceeded the highest input power P_{H}.

An occurrence of the partial short-circuit failure mode causes a target value F_{T}′ of the switching frequency F, at which the input power P has just reached the target value P_{T}, to be higher than a normal target value F_{T} of the switching frequency F.

From this viewpoint, the control unit 7 stores, in the memory 7b, the information I including the normal target value F_{T} of the switching frequency F at which the input power P has just reached the target value P_{T} when the discharge load 2 is in the normal state.

When determining whether the discharge load 2 has malfunctioned, the control unit 7 serves as the failure determiner 71 to calculate an absolute difference 8F between the target value F_{T}′ of the switching frequency F, at which the input power P has just reached the target value P_{T}, and the normal target value F_{T} of the switching frequency F stored in the memory unit 7b. This makes it possible for the failure determiner 71 to determine that the partial short-circuit failure mode has occurred in the discharge load 2 upon determining that the absolute difference δF is higher than a predetermined threshold δF_{TH}.

Additionally, an occurrence of the partial short-circuit failure mode causes the quality factor Q of the resonant behavior of the resonant inverter 3 to be higher, resulting in the fact that, the closer the switching frequency F to the resonant frequency Fr is, the rapidly higher the input power P is. The control unit 7 is capable of determining whether the partial short-circuit failure mode has occurred in the discharge load 2 using this feature.

Specifically, the failure determiner 71 can be configured to decrement the switching frequency F from the highest frequency F_{H} toward the lowest frequency F_{L} by the predetermined minute frequency ΔF while calculating an amount of change ΔP of the input power P for each decrement. Then, the failure determiner 71 determines that the partial short-circuit failure mode has occurred in the discharge load 2 upon determining that the ratio ΔP/ΔF becoming higher than a predetermined threshold Δ_{TH}.

Next, the following describes how the control unit 7, i.e. the failure determiner 71, determines that the partial open-circuit failure mode has occurred in the discharge load 2 based on the frequency characteristic of the input power P.

As illustrated in FIG. 10, a part 230 of at least one of the first and second wire members 23A and 23B having open-circuited in the partial open-circuit failure mode results in no discharges being generated in a part of the discharge cells 21 of the discharge load 2. This results in the total resistance R of the discharge load 2 being higher, so that the quality factor Q of the resonance behavior by the resonant inverter 3, which is expressed by “Q=(1/R)·\sqrt{(L/C)}”, being lower.

Additionally, a part 230 of at least one of the first and second wire members 23A and 23B having open-circuited in the partial open-circuit failure mode results in the capacitance C of the discharge load 2 being lower, so that the resonant frequency Fr becomes higher than its normal value.

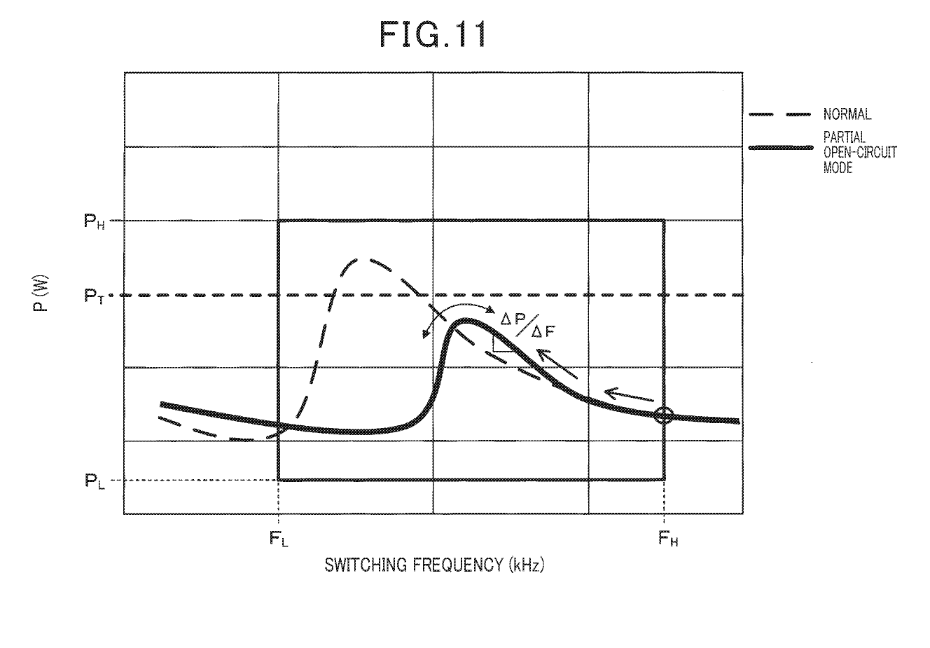

This results in the frequency characteristic of the input power P being illustrated in FIG. 11.

The control unit 7, i.e. the failure determiner 71, determines whether the partial open-circuit failure mode has occurred in the discharge load 2 in the following procedure.

Specifically, the failure determiner 71 is configured to perform

(1) A first task of decrementing the switching frequency F from the highest frequency F_{H} toward the lowest frequency F_{L} by the predetermined minute frequency ΔF while determining whether the input power P has reached the target value P_{T}

(2) A second task of reversing a decrease of the switching frequency F by the predetermined minute frequency ΔF to an increase of the switching frequency F by the predetermined minute frequency ΔF upon determining that the input power P has not reached the target value P_{T} and exceeded the peak P_{P}

(3) A third task of incrementing the switching frequency F by the predetermined minute frequency ΔF while determining whether the input power P has reached the target value P_{T}

(4) A fourth task of reversing an increase of the switching frequency F by the predetermined minute frequency ΔF to a decrease of the switching frequency F by the predetermined minute frequency ΔF upon determining that the input power P has exceeded the peak P_{P} and has not reached the target value P_{T}

That is, the failure determiner 71 is configured to repeat the first to fourth tasks, and determine that the partial open-circuit failure mode has occurred in the discharge load 2 upon determining that the number of reverse of the switching frequency F becomes equal to a predetermined number N_{TH}.

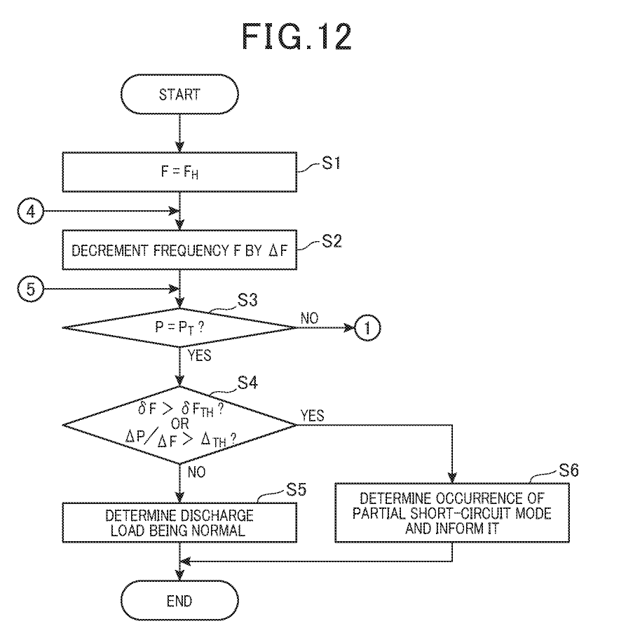

Next, the following describes a failure mode identifying routine carried out by the control unit 7, i.e. its CPU 7a, with reference to the flowchart of FIGS. 12 to 15. Note that the control unit 7 is programmed to execute the failure mode identifying routine each time a need arises for example.

In step S1 of the failure mode identifying routine, the control unit 7 serves as the failure determiner 71 to set the switching frequency F to the highest frequency F_{H}. Then, the control unit 7 serves as the failure determiner 71 to decrement the switching frequency F by the minute frequency ΔF in step S2.

Next, the control unit 7 serves as the failure determiner 71 to determine whether the input power P has reached the target value P_{T} in step S3. When it is determined that the input power P has reached the target value P_{T} (YES in step S3), the routine proceeds to step S4. In step S4, the control unit 7 serves as the failure determiner 71 to perform

(1) A first determination of whether the absolute difference δF is higher than the threshold δF_{TH}

(2) A second determination of whether the ratio ΔP/ΔF is higher than the threshold Δ_{TH}

Neither the first determination nor the second determination are affirmative (NO in step S4), the control unit 7 serves as the failure determiner 71 to determine that the discharge load 2 is in the normal state (see FIG. 3), then starting generation of ozone.

Otherwise, when it is determined that at least one of the first and second determinations is affirmative (YES in step S4), the control unit 7 serves as the failure determiner 71 to determine that a failure based on the partial short-circuit failure mode has occurred in the discharge load 2 (see FIG. 9) in step S6. Then, the control unit 7 serves as the failure determiner 71 to inform, for example, the external controller 100 or a driver of the vehicle about the occurrence of the partial short-circuit failure mode in the discharge load 2.

Otherwise, when it is determined that the input power P has not reached the target value P_{T} (NO in step S3), the routine proceeds to step S7. In step S7, the control unit 7 serves as the failure determiner 71 to determine whether the switching frequency F has reached the lowest frequency F_{L}. When it is determined that the switching frequency F has reached the lowest frequency F_{L} (YES in step S7), the routine proceeds to step S8.

In step S8, the control unit 7 serves as the failure determiner 71 to determine whether a value of the input power P is located within the frequency range F_{H} to F_{L} at the timing when the switching frequency F has just reached the lowest frequency F_{L}. Upon determining that the value of the input power P is located within the frequency range F_{H} to F_{L} at the timing when the switching frequency F has just reached the lowest frequency F_{L} (YES in step S8), the routine proceeds to step S9.

In step S9, the control unit 7 serves as the failure determiner 71 to determine that a failure based on the full short-circuit failure mode has occurred in the discharge load 2 (see FIG. 5) in step S9. Then, the control unit 7 serves as the failure determiner 71 to inform, for example, the external controller 100 or a driver of the vehicle about the occurrence of the full short-circuit failure mode in the discharge load 2.

Otherwise, upon determining that the value of the input power P is located outside the frequency range F_{H} to F_{L} at the timing when the switching frequency F has just reached the lowest frequency F_{L} (NO in step S8), the routine proceeds to step S10.

In step S10, the control unit 7 serves as the failure determiner 71 to determine that a failure based on the full open-circuit failure mode has occurred in the discharge load 2 (see FIG. 7) in step S10. Then, the control unit 7 serves as the failure determiner 71 to inform, for example, the external controller 100 or a driver of the vehicle about the occurrence of the full open-circuit failure mode in the discharge load 2.

Otherwise, if the switching frequency F has not reached the lowest frequency F_{L} (NO in step S7), the routine proceeds to step S11. In step S11, the control unit 7 serves as the failure determiner 71 to determine whether the control unit 7 has reversed an increase or decrease of the switching frequency F at least the predetermined number N_{TH} of times.

Upon determining that the control unit 7 has reversed an increase or decrease of the switching frequency F at least the predetermined number N_{TH} of times (YES in step S11), the control unit 7 serves as the failure determiner 71 to determine that a failure based on the partial open-circuit failure mode has occurred in the discharge load 2 (see FIG. 11) in step S12. Then, the control unit 7 serves as the failure determiner 71 to inform, for example, the external controller 100 or a driver of the vehicle, such as a user of the discharge generator 1, about the occurrence of the partial open-circuit failure mode in the discharge load 2.

Otherwise, upon determining that the control unit 7 has not reversed an increase or decrease of the switching frequency F at least the predetermined number N_{TH} of times (NO in step S11), the routine proceeds to step S13.

In step S13, the control unit 7 serves as the failure determiner 71 to determine whether the input power P has passed over the peak P_{P} in an increase direction or a decrease direction. Upon determining that the input power P has passed over the peak P_{P} (YES in step S13), the control unit 7 serves as the failure determiner 71 to reverse an increase or a decrease of the switching frequency Fin step S14. After the operation in step S14, the control unit 7 returns to step S3, and repeatedly performs the following operations from step S3.

Otherwise, upon determining that the input power P has not passed over the peak P_{P} (NO in step S13), the control unit 7 returns to step S2, and repeatedly performs the following operations from step S2.

Next, the following describes how the discharge generator 1 works, and also describes technical benefits achieved by the discharge generator 1.

The discharge generator 1 includes the failure determiner 71 configured to change the switching frequency F of each switch 4 while monitoring and analyzing the frequency characteristic of the input power P. This analysis enables whether the discharge load 2 is in a normal state or at least one of the failure modes has occurred in the discharge load 2.

The control unit 7 is configured to determine whether at least one of failure modes has occurred in the discharge load 2 at least one of before and after controlling the resonant inverter 3 to cause the discharge load 2 to perform the discharge mode for generating a discharge to thereby generate ozone.

The control unit 7 can be configured to determine whether at least one of failure modes has occurred in the discharge load 2 while controlling the resonant inverter 3 to cause the discharge load 2 to generate ozone. Unfortunately, because this modified configuration needs to adjust the output power P to be close to the target output power P_{O}*, this modified condition makes it difficult to freely change the switching frequency F, resulting in a reduction in the failure-mode identifying accuracy of the control unit 7.

In contrast, the control unit 7 of the first embodiment is configured, i.e. programmed, to perform the failure mode identifying routine before or after causing the discharge load 2 perform the discharge mode for generating a discharge to thereby generate ozone. This ensures sufficient time for performing the failure mode identifying routine, making it possible to freely change the switching frequency F. This therefore enables the control unit 7 to identify which of the failure modes has occurred in the discharge load 2 with higher accuracy.

Additionally, the control unit 7 is configured to change the frequency f of each switch 4 within the frequency range F_{H} to F_{L} while monitoring or measure the input power P, and identify which of the failure modes has occurred in the discharge load 2 in accordance with a predetermined actual relationship among the monitored value of the input power P, the frequency range F_{H} to F_{L}, the input power range P_{L} to P_{H} corresponding to the frequency range F_{H} to F_{L}, and the target value P_{T} of the input power P.

As described above, as compared with a predetermined reference relationship of the parameters including the input power P, the frequency range F_{H} to F_{L}, the input power range P_{L} to P_{H}, and the target value P_{T} of the input power P, the actual relationship changes due to the occurrence of at least one of the failure modes in the discharge load 2; the changed portion depends on the occurrence of at least one of the failure modes.

For example, the occurrence of one of the failure modes causes the input power P to have exceeded the higher input power P_{H} (see FIG. 9), and the occurrence of another one of the failure modes causes the input power P to have decreased down the lower input power P_{L} (see FIG. 7). In addition, the occurrence of another one of the failure modes causes the input power P not to have reached the target value P_{T} of the input power P

Specifically, the failure determiner 71 is configured to identify which of the full short-circuit failure mode (see FIGS. 4 and 5), the full open-circuit failure mode (see FIGS. 6 and 7), the partial short-circuit failure mode (see FIGS. 8 and 9), and the partial open-circuit failure mode (see FIGS. 10 and 11) has occurred in the discharge load 2. These failure modes provide widely different frequency characteristics of the input power P, respectively. Analyzing the actual frequency characteristic of the input power P therefore enables which of these failure modes having occurred in the discharge load 2 to be easily identified.

The failure determiner 71 is configured to decrement the switching frequency F from the highest frequency F_{H} toward the lowest frequency F_{L} by the predetermined minute frequency ΔF.

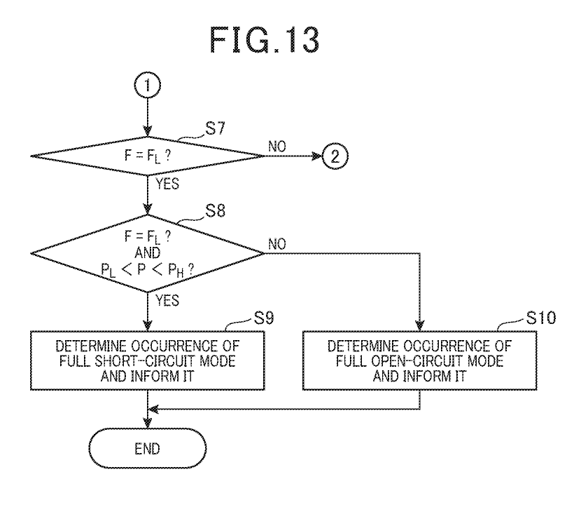

Then, the failure determiner 71 determines that the full short-circuit failure mode has occurred in the discharge load 2 upon determining that the input power P is located within the input power range P_{L} to P_{H} when the switching frequency F becomes the lowest frequency F_{L} (see FIGS. 5 and 13).

This configuration enables whether the full short-circuit failure mode has occurred in the discharge load 2 to be reliably determined.

Note that the failure determiner 71 can be configured to increment the switching frequency F from the lowest frequency F_{L} toward the highest frequency F_{H} by the predetermined minute frequency ΔF. Then, the failure determiner 71 can determine that the full short-circuit failure mode has occurred in the discharge load 2 upon determining that the input power P is located within the input power range P_{L} to P_{H} when the switching frequency F becomes the highest frequency F_{H}.

The failure determiner 71 is also configured to decrement the switching frequency F from the highest frequency F_{H} toward the lowest frequency F_{L} by the predetermined minute frequency ΔF.

Then, the failure determiner 71 determines that the full open-circuit failure mode has occurred in the discharge load 2 upon determining that the input power P is located outside the input power range P_{L} to P_{H}, i.e. is lower than the lowest input power P_{L}, when the switching frequency F becomes the lowest frequency F_{L} (see FIGS. 7 and 13).

This configuration enables whether the full open-circuit failure mode has occurred in the discharge load 2 to be reliably determined.

Note that the failure determiner 71 can be configured to increment the switching frequency F from the lowest frequency F_{L} toward the highest frequency F_{H} by the predetermined minute frequency ΔF. Then, the failure determiner 71 can determine that the full open-circuit failure mode has occurred in the discharge load 2 upon determining that the input power P is located outside the input power range P_{L} to P_{H} when the switching frequency F becomes the highest frequency F_{H}.

The control unit 7 stores, in the memory 7b, the information I including the normal target value F_{T} of the switching frequency F at which the input power P has just reached the target value P_{T} when the discharge load 2 is in the normal state.

Then, the failure determiner 71 determines whether the absolute difference δF is higher than the threshold δF_{TH} (see step S4 of FIG. 12)

When it is determined that the absolute difference OF is higher than the threshold δF_{TH} (YES in step S4), the failure determiner 71 determines that a failure based on the partial short-circuit failure mode has occurred in the discharge load 2.

This configuration enables whether the partial short-circuit failure mode has occurred in the discharge load 2 to be reliably determined.

In addition, the failure determiner 71 determines whether the ratio ΔP/ΔF is higher than the threshold ΔT_{H} (see step S4 of FIG. 12).

When it is determined that the ratio ΔP/ΔF is higher than the threshold ΔT_{H} (YES in step S4), the failure determiner 71 determines that a failure based on the partial short-circuit failure mode has occurred in the discharge load 2.

This configuration enables whether the partial short-circuit failure mode has occurred in the discharge load 2 to be reliably determined.

Note that the failure determiner 71 of the first embodiment determines that a failure based on the partial short-circuit failure mode has occurred in the discharge load 2 upon determining that at least one of the following first and second conditions is satisfied:

The first condition that the absolute difference δF is higher than the threshold δF_{TH}, which is expressed by “δF>δF_{TH}”.

The second condition that the ratio ΔP/ΔF is higher than the threshold Δ_{TH}, which is expressed by “ΔP/ΔF>Δ_{TH}”.

The failure determiner 71 can use another condition for determining whether the partial short-circuit failure mode has occurred in the discharge load 2.

Specifically, the failure determiner 71 can be configured to decrement the switching frequency F from the highest frequency F_{H} toward the lowest frequency F_{L} by the predetermined minute frequency ΔF, and determine whether the input power P has exceeded the highest input power P_{H} of the input power range P_{L} to P_{H}. Then, the failure determiner 71 can be configured to determine that the partial short-circuit failure mode has occurred in the discharge load 2 upon determining that the input power P has exceeded the highest input power P_{H} of the input power range P_{L} to P_{H}.

That is, the failure determiner 71 can be configured to determine that the input power P has exceeded the highest input power P_{H} of the input power range P_{L} to P_{H} upon determining that the following third condition is satisfied:

The third condition is that the input power P has exceeded the highest input power P_{H} of the input power range P_{L} to P_{H}, which is expressed by “P>P_{H}”.

This modification enables whether the partial short-circuit failure mode has occurred in the discharge load 2 to be more easily determined.

The failure determiner 71 can be configured to individually determine whether the first to third conditions are satisfied or determine whether a combination of at least two of the first to third conditions is satisfied.

For example, the failure determiner 71 can be configured to determine whether the third condition is satisfied after determining that the first condition is satisfied, and determine that the partial short-circuit failure mode has occurred in the discharge load 2 upon determining that the third condition is satisfied. Similarly, the failure determiner 71 can be configured to determine whether the third condition is satisfied after determining that both the first and second conditions are satisfied, and determine that the partial short-circuit failure mode has occurred in the discharge load 2 upon determining that the third condition is satisfied.

The failure determiner 71 is configured to decrement the switching frequency F from the highest frequency F_{H} toward the lowest frequency F_{L} by the predetermined minute frequency ΔF.

Then, the failure determiner 71 reverses an increase or a decrease of the switching frequency F (see step S14) upon determining that the input power P has not reached the target value P_{T} (NO in step S3) and the input power P has not passed over the peak P_{P} (NO in step S13). In addition, the failure determiner 71 determines that a failure based on the partial open-circuit failure mode has occurred in the discharge load 2 upon determining that the failure determiner 71 has reversed an increase or decrease of the switching frequency F at least the predetermined number N_{TH} of times (see steps S11 and S12).

This enables whether the partial open-circuit failure mode has occurred in the discharge load 2 to be reliably determined.

The failure determiner 71 is configured to inform, for example, the external controller 100 or a driver of the vehicle about the occurrence of the identified failure mode as illustrated in FIGS. 12 to 14 (see one of steps S6, S9, S10, and S12).

This configuration enables one of predetermined counter measures to be selected for the identified one of the failure modes. For example, the control unit 7 can be configured to perform

(1) The first counter measure to stop output of the resonant inverter 2 upon identifying that the full short-circuit mode has occurred in the discharge load 2

(2) The second counter measure to adjust the output of the resonant inverter 2 to the target value P_{T} upon identifying that the full open-circuit mode has occurred in the discharge load 2

(3) The first counter measure to stop output of the resonant inverter 2 upon identifying that the partial short-circuit mode has occurred in the discharge load 2

(4) The fourth counter measure to adjust the output of the resonant inverter 2 to the peak P_{P} upon identifying that the partial open-circuit mode has occurred in the discharge load 2

As described above, the first embodiment provides the discharge generator 1, which is capable of determining whether at least one of the failure modes has occurred in the discharge load 2.

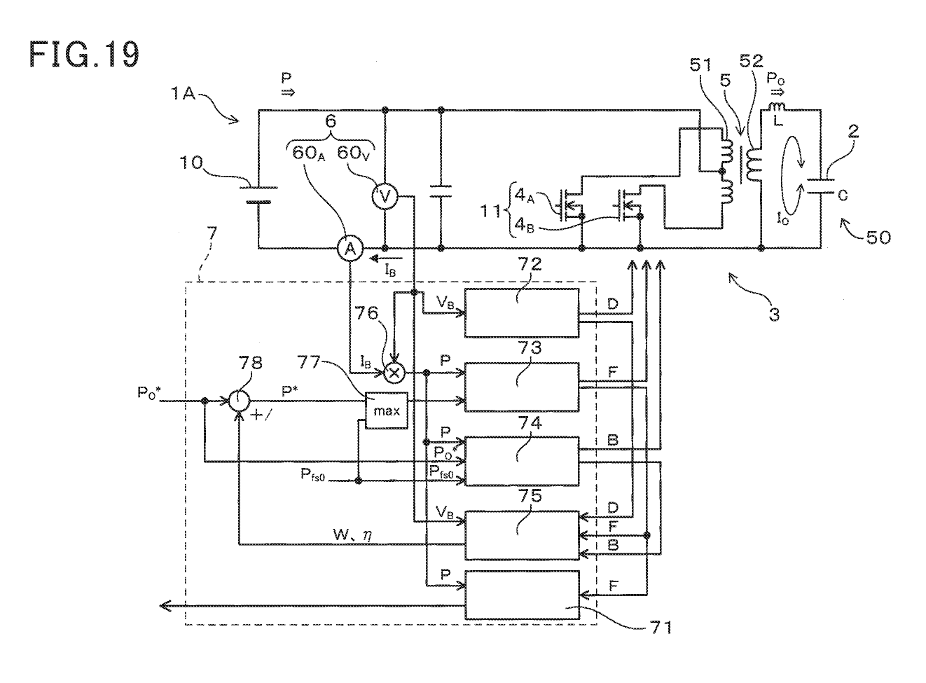

The discharge generator 1 is comprised of the push-pull circuit 11 and the resonant tank circuit 12 based on the switches 4_{A}, 4_{B}, 4_{C}, and 4_{D}, but the present disclosure is not limited thereto. Specifically, a modified discharge generator 1A can be configured such that only the push-pull circuit 11 is connected to the primary coil 51 of the transformer 5 without providing the resonant tank circuit 12 (see FIG. 19). Additionally, a modified discharge generator 1B can be comprised of a bridge inverter including the switches 4 (4_{A} to 4_{D}) connected in an H bridge configuration. In addition, the smoothing capacitor 40 is connected in parallel to the DC power source 10. The positive electrode of the smoothing capacitor 40 is connected to the first end of each switch 4_{C}, 4_{D}, and the negative electrode of the smoothing capacitor 40 is connected to the first end of each switch 4_{A}, 4_{B}.

### Second Embodiment

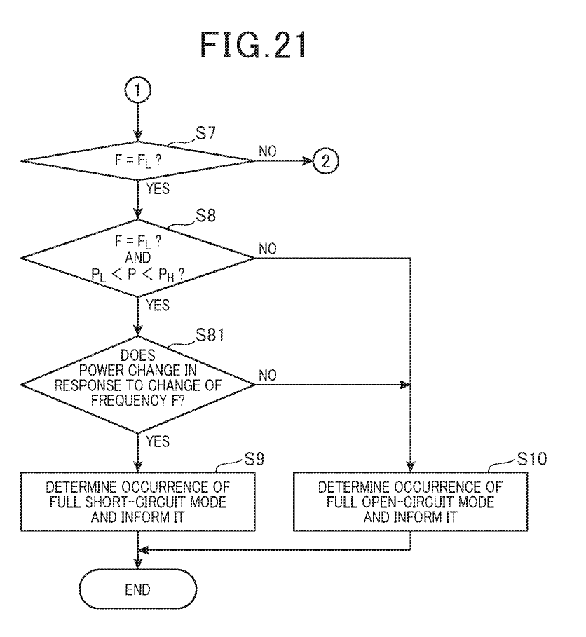

The following describes a discharge generator 1 according to the second embodiment of the present disclosure with reference to FIG. 21. The configuration and functions of the discharge generator 1 according to the second embodiment are mainly different from those of the discharge generator 1 according to the first embodiment by the following points. The following therefore mainly describes the different points.

As illustrated in FIG. 21, the failure mode identifying routine according to the second embodiment is slightly modified as compared with the failure mode identifying routine according to the first embodiment.

Specifically, when it is determined that the value of the input power P is located within the frequency range F_{H} to F_{L} at the timing when the switching frequency F has just reached the lowest frequency F_{L} (YES in step S8), the modified routine proceeds to step S81.

In step S81, the failure determiner 71 changes the switching frequency F within the frequency range F_{H} to F_{L} to thereby determine whether the input power P changes in response to change of the switching frequency F.

Upon determining that the input power P changes in response to change of the switching frequency F (YES in step S81), the control unit 7 serves as the failure determiner 71 to determine that a failure based on the full short-circuit failure mode has occurred in the discharge load 2 (see FIG. 5) in step S9.

Otherwise, upon determining that the input power P does not change in response to change of the switching frequency F (NO in step S81), the control unit 7 serves as the failure determiner 71 to determine that a failure based on the full open-circuit failure mode has occurred in the discharge load 2 (see FIG. 7) in step S10.

The discharge generator 1 according to the second embodiment is configured to determine that the full short-circuit mode has occurred in the discharge load 2 only upon determining that the input power P changes in response to change of the switching frequency F. This configuration therefore enables whether the full short-circuit failure mode has occurred in the discharge load 2 to be more reliably determined in addition to the same technical benefits as those achieved by the first embodiment.

While the illustrative embodiments and their modifications of the present disclosure have been described herein, the present disclosure is not limited to the embodiments and their modifications described herein. Specifically, the present disclosure includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

1. A discharge generator comprising:
a discharge load;
a resonant inverter for converting a direct-current input voltage supplied from a direct-current power source into an alternating-current voltage, and applying the alternating-current voltage to the discharge load, thus causing the discharge load to perform a discharge mode for generating a discharge,
the resonant inverter comprising:
a switch connected to the direct-current power source; and
a transformer comprising a primary coil connected to the switch, and a secondary coil magnetically coupled to the primary coil and connected to the discharge load;
a power measuring unit configured to measure input power supplied from the direct-current power source; and
a control unit configured to:
control on-off switching operations of the switch to thereby convert the input direct-current voltage to the alternating-current voltage;
change a switching frequency of the on switching operations of the switch while performing an analysis of a frequency characteristic of the input power based on change of the switching frequency; and
perform a failure determination of whether the discharge load is a normal state or at least one of predetermined failure modes has occurred in the discharge load in accordance with a result of the analysis of the frequency characteristic of the input power.

2. The discharge generator according to claim 1, wherein:
the control unit is configured to perform the failure determination at least one of before performing the discharge mode and after performing the discharge mode.

3. The discharge generator according to claim 1, wherein:
the control unit stores information including:
a predetermined frequency range of the switching frequency from a predetermined lowest frequency to a predetermined highest frequency inclusive;
a power range of the input power from lowest input power to highest input power inclusive; and
a target value of the input power previously determined within the power range;
the discharge load has a resonant frequency, the resonant frequency being located within the frequency range upon the discharge load being in the normal state;
a peak of the input power is located within the power range upon the discharge load being in the normal state;
the input power is located within the power range independently of any value of the switching frequency within the frequency range; and
the control unit is configured to:
change the switching frequency within the frequency range while monitoring a value of the input power; and
perform the failure determination in accordance with a relationship among the monitored value of the input power, the frequency range, the power range, and the target value of the input power.

4. The discharge generator according to claim 3, wherein:
the discharge load comprises:
a plurality of discharge cells each for generating a discharge, each of the discharge cells including at least a pair of first and second discharge electrodes facing each other; and
a first wire member connecting the first discharge electrodes of the discharge cells; and
a second wire member connecting the second discharge electrodes of the discharge cells; and
the control unit is configured to determine whether at least one of a full short-circuit failure mode, a full open-circuit failure mode, a partial short-circuit failure mode, and a partial open-circuit failure mode has occurred as the predetermined failure modes in the discharge load.

5. The discharge generator according to claim 4, wherein:
the control unit is configured to:
change the switching frequency within the frequency range while monitoring a value of the input power; and
determine that the full short-circuit failure mode has occurred in the discharge load upon determining that:
the input power has not reached the target value of the input power; and
the value of the input power is located within the power range when a value of the switching frequency has just reached one of the highest frequency and the lowest frequency.

6. The discharge generator according to claim 4, wherein:
the control unit is configured to:
change the switching frequency within the frequency range while monitoring a value of the input power; and
determine that the full open-circuit failure mode has occurred in the discharge load upon determining that:
the value of the input power is located outside the power range when the value of the switching frequency has just reached one of the highest frequency and the lowest frequency.

7. The discharge generator according to claim 4, wherein:
the control unit is configured to:
store a normal target value of the switching frequency at which the input power has just reached the target value upon the discharge load being in the normal state;
calculate an absolute difference between the value of the switching frequency at which the input power has just reached the target value and the normal target value; and
determine that the partial short-circuit failure mode has occurred in the discharge load upon determining that the absolute difference is higher than a predetermined threshold.

8. The discharge generator according to claim 4, wherein:
the control unit is configured to:
change the switching frequency within the frequency range while monitoring the value of the input power; and
determine that the partial short-circuit failure mode has occurred in the discharge load upon determining that:
the input power has exceeded the highest input power of the power range.

9. The discharge generator according to claim 4, wherein:
the control unit is configured to:
change the switching frequency within the frequency range by a predetermined frequency while monitoring a change of the input power; and
determine that the partial short-circuit failure mode has occurred in the discharge load upon determining that:
a ratio of the change of the input power to the predetermined frequency is higher than a predetermined threshold.

10. The discharge generator according to claim 4, wherein:
the control unit is configured to:
reverse an increase or a decrease of the switching frequency upon determining that the input power has passed over the peak;
determine whether the control unit has reversed an increase or decrease of the switching frequency at least a predetermined number of times; and
determine that the partial open-circuit failure mode has occurred in the discharge load upon determining that the control unit has reversed an increase or decrease of the switching frequency at least the predetermined number of times.

11. The discharge generator according to claim 1, wherein:
the control unit is configured to inform at least one of a user of the discharge generator and an external device about an occurrence of at least one of the failure modes in the discharge load upon determining that at least one of the failure modes has occurred in the discharge load.
